(19) United States
(12) Patent Application Publication
(10) Pub. No.: US 2025/0143224 A1
(43) Pub. Date: May 8, 2025

(54) SLANTED BALE SPLITTING KNIFE

(71) Applicant: CNH Industrial America LLC, New Holland, PA (US)

(72) Inventor: Devin Cooley, New Holland, PA (US)

(73) Assignee: CNH Industrial America LLC, New Holland, PA (US)

(21) Appl. No.: 18/922,489

(22) Filed: Oct. 22, 2024

Related U.S. Application Data
(60) Provisional application No. 63/547,428, filed on Nov. 6, 2023.

(51) Int. Cl. A01F 15/08; A01F 15/10; A01F 15/14

(52) U.S. Cl. CPC A01F 15/0875; A01F 15/14; A01F 2015/108

(57) ABSTRACT

An agricultural baler includes a bale chamber having a discharge outlet and a bale splitting system. The bale splitting system includes a cutting mechanism arranged downstream of the discharge outlet and configured to split the bale into two smaller bales. The cutting mechanism is angled forwardly or rearwardly relative to a top wall or a bottom wall of the bale chamber. A bale splitting system that includes two cutting mechanisms angled in opposite directions relative to the bottom wall or the top wall of the bale chamber is also provided.

### CROSS REFERENCE TO RELATED APPLICATION

This application claims priority to U.S. Provisional Patent Application Ser. No.: 63/547,428 filed Nov. 6, 2023, the content of such application being incorporated by reference herein in its entirety.

### FIELD OF THE INVENTION

The present invention relates to agricultural balers of the type commonly referred to as square balers that produce bales having a rectangular cross section, and, more particularly, to bale splitting systems used with square agricultural balers.

### BACKGROUND OF THE INVENTION

Agricultural harvesting machines, such as balers, for example, are used to consolidate and package crop material so as to facilitate the storage and handling of the crop material for later use. In the case of hay, a mower-conditioner cuts and conditions the crop material for windrow drying in the sun. In the case of straw, an agricultural combine discharges non-grain crop material from the rear of the combine defining the straw (such as wheat or oat straw, for example) which is to be picked up by the baler. The cut crop material is typically raked and dried, and a baler, such as a square baler or a round baler, for example, straddles the windrows and travels along the windrows to pick up the crop material and form it into square or round bales. More specifically, a pickup unit at the front of the baler gathers the cut and windrowed crop material from the ground and then conveys the cut crop material into a bale-forming chamber within the baler where the crop material is compacted, typically by means of a reciprocating plunger. The bale-forming chamber usually includes a device for tying bales and a discharge outlet, for example connected to a discharge chute for gently lowering bales onto the field. During normal baling operation, tied bales are ejected from the baler through action of the plunger.

Square agricultural balers are sometimes preferred because the square-shaped bales facilitate stacking, delivery, and use. During baling, however, a small square baler has a relatively small capacity because a small square baler typically only produces one small bale at a time. Farmers either need to have multiple small square balers operating at the same time in order to harvest crop material from the field efficiently or make large square bales and convert them later into bundles of small square bales. These methods are inefficient and expensive.

Described herein is an agricultural baler that can produce small square bales at a fast rate and without the added expense of multiple balers.

### SUMMARY OF THE INVENTION

Described herein is a bale splitting system for agricultural balers. The bale splitting system receives a large square bale from the bale-forming chamber and splits the large bale into two small square bales before depositing the bale on the ground surface of the field.

An agricultural baler includes a bale splitting system that splits a large square bale into two small square bales. The bale splitting system includes a cutting mechanism configured to split the bale into two smaller bales. The cutting mechanism is slanted at an adjustable angle relative to the bottom wall or the top wall of the bale chamber. The position of the cutting mechanism is adjustable relative to the front wall and the rear wall of the bale chamber. The slanted configuration improves the cutting quality of the bales.

A bale splitting system with two cutting mechanisms that are slanted in the opposite directions can additionally improve the cutting quality and the shape of the bales.

### BRIEF DESCRIPTION OF THE DRAWINGS

The drawing figures depict one or more implementations, by way of example only, not by way of limitations. In the figures, like reference numerals refer to the same or similar elements.

FIG. 1 is a side view of a square agricultural baler to which a bale splitting system according to embodiments described herein may be applied.

FIG. 2 is a side view of a bale splitting system of the baler of FIG. 1, which is shown schematically, according to an embodiment.

FIG. 3 is a top plan view of the bale splitting system of FIG. 2, which is shown schematically, according to an embodiment.

FIG. 4 is a side view of a bale splitting system of the baler of FIG. 1, which is shown schematically, according to another embodiment.

FIG. 5A is a front view of the double knives of the bale splitting system of FIG. 4, according to an embodiment.

FIG. 5B is a top sectional view of the double knives of the bale splitting system of FIG. 4, according to an embodiment.

FIG. 5C is a side view of the double knives of the bale splitting system of FIG. 4, according to an embodiment.

FIG. 5D is a side sectional view of the double knives of the bale splitting system of FIG. 4, according to an embodiment.

### DETAILED DESCRIPTION OF THE INVENTION

The terms “forward,” “rearward,” “upward,” “downward,” “left,” and “right,” or “top” or “bottom,” when used in connection with the agricultural baler described herein and/or components thereof are usually determined with reference to the direction of forward operative travel of the towing vehicle and the height of the baler, but they should not be construed as limiting. The terms “longitudinal” and “transverse” are determined with reference to the fore-and-aft direction of the towing vehicle and the width of the baler, and are equally not to be construed as limiting.

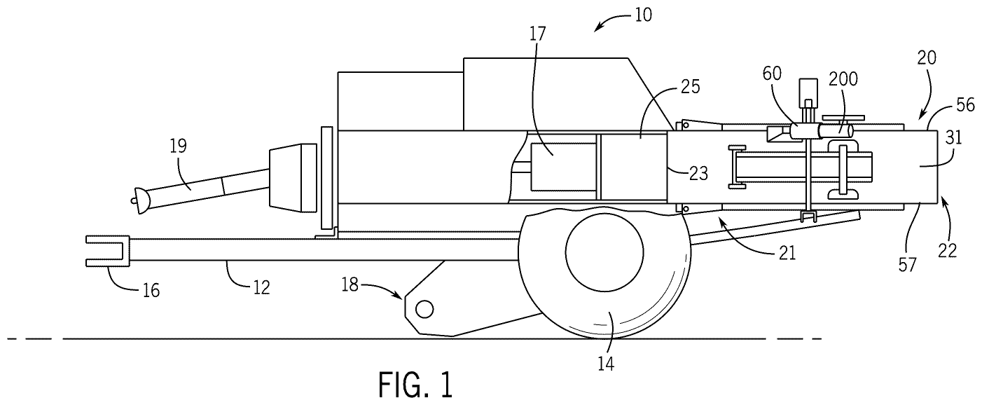

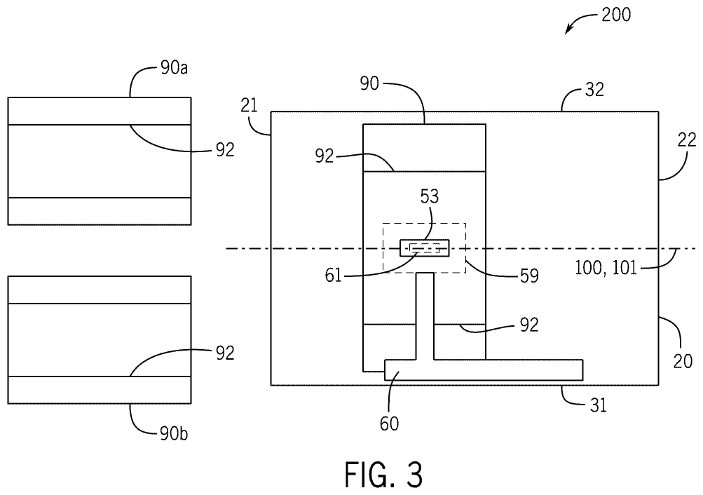

Referring now to the drawings, and more particularly to FIG. 1, illustrated is an agricultural baler 10 for producing oblong bales (shown as 90 in FIG. 3) having generally rectangular cross-sections, generally referred to as square bales. The baler 10 includes a frame 12 that is ground-supported by wheels 14 (only one shown). A tongue 16 projects forwardly from the frame 12 and is configured for connection to a towing vehicle, such as an agricultural tractor (not shown), which is equipped with a power take-off shaft 19 for delivering motive power to the various driven components in the baler 10.

As shown in FIG. 1, a pick-up assembly 18 is provided in order to take up a swath or windrow of harvested crop from the ground and to deliver it toward a bale chamber 20. The bale chamber 20 includes a forward portion 21 and a rearward portion 22. A plunger 17 is reciprocally disposed adjacent to the forward portion 21 of bale chamber 20 to form crop material into square bales in a conventional manner. When baling a crop material (such as hay) in a square bale, the baler 10 may be outfitted with a pre-chamber that forms a slice of bale material. The pre-formed slice may be injected into the main bale chamber where a bale is formed. Once a slice of crop material is formed and ejected from the pre-chamber, the plunger 17, which may be continually driving hydraulically like a piston in an engine, for example, moves from the forward portion 21 to the rearward portion 22 of the bale chamber 20, forcing a slice of crop material to compress. In this manner, slices of crop material are pushed toward the rearward portion 22 of the bale chamber 20, and are compressed while forming the bale. The formed square bales are urged sequentially through the bale chamber 20 to a tying assembly 25 that wraps and ties around the bale a suitable material, such as twine, for example (shown as 92 in FIG. 3), and then discharged from the baler 10 onto the ground surface of the field.

Referring back to FIG. 1, the bale chamber 20 is defined by an upper side (e.g., roof) 56, a lower side (e.g., floor) 57, and a pair of generally opposing and parallel side walls 31, 32 (only side wall 31 is shown in FIG. 1), forming a generally rectangular opening through which bales pass forwardly to rearwardly along a bale travel axis (shown as axis 100 in FIG. 3). The upper side 56 may be open. The rectangular shape of bale chamber 20 generally establishes the cross-sectional rectangular size of the bale. Side walls 31, 32 are typically fixed with respect to frame 12, but may include provisions for adjusting the size of the bale chamber 20. A bar 60 or other mounting surface (generically referred to as a ‘mount’) may be arranged on the upper side (e.g., roof) 56 of the baler 10. A similar bar or other mounting surface may be arranged on the lower side (e.g., floor) 57 or the side walls 31, 32 of the baler 10. The bar 60 may be used for mounting the bale splitting system described hereinafter.

Further details of baler 10 may be described in U.S. Pat. No. 7,975,607, which is incorporated by reference herein in its entirety and for all purposes.

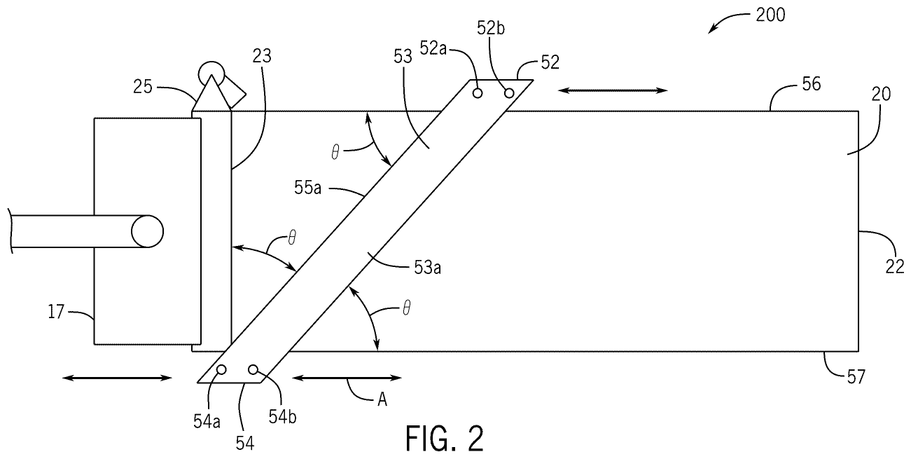

In a first aspect, a bale splitting system 200 is provided for an agricultural baler 10, more particularly a large square baler or a rectangular baler, i.e., a machine for forming square or rectangular bales from agricultural crop material. In a large square baler, for example, large bales are discharged in a longitudinal discharge direction from a discharge outlet 23 (FIGS. 1 and 2) arranged at the forward portion 21 of the bale-forming chamber 20, usually with the larger side of the bale positioned perpendicular relative to the side walls 31, 32 of the baler 10, as illustrated in FIG. 3, for example. The bale splitting system 200 includes a cutting device or a cutting mechanism, such as a knife or a wedge, for example, attached to the back of the baler 10.

The bale splitting system 200 receives large bales 90 before, while the bales are bound with twine 92, or after the large bales 90 are bound with twine 92, and splits them into two small square bales before discharging bales on the surface of the ground. In other words, the bale splitting system 200 cuts or splits the large bale 90 in two smaller bales before or while the large bale 90 is tied or bound with twine 92, or after the large bale 90 is tied or bound with twine 92. The bale splitting system 200 cuts the large bale 90 along a line that runs parallel to the longitudinal discharge direction (i.e., the fore-aft direction) or parallel to the bale travel axis 100.

The bale splitting system 200 according to embodiments of the present invention may be a separate structure for being added or retro-fitted into an existing agricultural baler. Alternatively, the bale splitting system 200 may be built into agricultural baler 10.

Referring now specifically to FIG. 2, a bale splitting system 200 includes a cutting device, such as a knife 53, for example. The knife 53 includes a blade 53a, for example. The knife blade 53a is slanted or angled at an angle 0 relative to the upper side (e.g., roof) 56 and the lower side (e.g., floor) 57 of the bale chamber 20. The position of the knife blade 53a relative to the forward portion 21 and the rearward portion 22 of the bale chamber 20 is adjustable. For example, the position of the knife blade 53a can be adjusted in the forward direction (left in FIG. 2) or in the rearward direction (right in FIG. 2) relative to the discharge outlet 23 of the bale-forming chamber 20, as shown by arrow A in FIG. 2. The angle 0 between the knife blade 53a and the upper side (e.g., roof) 56 and the lower side (e.g., floor) 57 of the bale chamber 20 is also adjustable.

The knife 53 can be mounted to the back of the baler 10, between the forward portion 21 and the rearward portion 22 of the bale chamber 20, and downstream of the plunger 17 and the tying assembly 25 that wraps and ties twine 92 around the bale 90. For example, one side 52 of the knife 53 can be mounted (e.g., fixed) to an upper bar (similar to the bar 60 in FIG. 1) arranged at the upper side (e.g., roof) 56 of the baler 10, via mounting holes 52a, 52b and corresponding fasteners, for example, while the other side 54 of the knife 53 can be mounted (e.g., fixed) to a similar bar arranged at the lower side (e.g., floor) 57 of the baler 10, via mounting holes 54a, 54b and corresponding fasteners, for example. Alternatively, one side 52 of the knife 53 can be mounted to an upper bar (similar to the bar 60 in FIG. 1) arranged at the upper side (e.g., roof) 56 of the baler 10, via an actuator 59 (shown in FIG. 3), for example, while the other side 54 of the knife 53 can be mounted to a similar bar arranged at the lower side (e.g., floor) 57 of the baler 10, again via a similar actuator 59, for example. When the knife 53 is mounted, the knife blade 53a extends diagonally in a slanted or angled manner between the upper side (e.g., roof) 56 and the lower side (e.g., floor) 57 of the bale chamber 20. The knife blade 53a may be arranged in a central position between the side walls 31, 32 of the baler 10 and parallel to the side walls 31, 32 of the baler 10.

As shown in FIG. 2, the knife blade 53a has a sharpened angled or serrated edge 55a, for example. The angled edge 55a extends diagonally in a slanted or angled manner between the upper side (e.g., roof) 56 and the lower side (e.g., floor) 57 of the bale chamber 20, such that the knife blade 53a can split the bale 90 in the middle, forming two smaller square bales 90a and 90b. The two smaller square bales 90a and 90b are illustrated schematically in FIG. 3, which is a top plan view of the bale splitting system 200 of FIG. 2.

Turning back to FIG. 2, the sharp edge 55a of the knife blade 53a is arranged to face the discharge outlet 23 of the bale-forming chamber 20 proximal to the tying assembly 25, and the large bales 90 advancing from the discharge outlet 23 of the bale-forming chamber 20 through the baler 10. The sharp edge 55a is configured to pass through the bale 90, along the width-wise centerline 101 of the bale 90 (FIG. 3), thereby slicing the bale 90 in the middle, forming two smaller square bales 90a and 90b.

In operation, the formed large square bales 90 advance sequentially through the bale chamber 20, where they are bound or in the process of being bound with a suitable material, such as twine 92, for example (shown in FIG. 3). As illustrated in FIG. 3, the length dimension of the bales 90 extends transversely between the side walls 31, 32 of the baler 10, and the height dimension of the bales 90 extends between the upper side (e.g., roof) 56 and the lower side (e.g., floor) 57 of the baler 10. Before the unbound bale 90, partially bound bale 90, or the bound with twine 92 bale 90, is discharged from the discharge chute of the baler 10 to the ground surface of the field, the bale 90 is pushed against and past the knife blade 53a. The knife blade 53a splits each bale 90 in along the centerline 101 while the bale 90 is still in the bale chamber 20, forming two small bales 90a and 90b (FIG. 3).

The knife blade 53a is arranged in a central position substantially corresponding to the forward-rearward bale travel axis 100 of the bale chamber 20 (FIG. 3) such that the knife blade 53a splits each bale 90 along the centerline 100 of the bale 90 and between the twine 92, without cutting the twine 92.

Turning back to FIG. 2, the position of the knife blade 53a can be adjusted forwardly or rearwardly relative to the discharge outlet 23 of the bale-forming chamber 20, and relative to the forward portion 21 and the rearward portion 22 of the bale chamber 20. The angle θ between the knife blade 53a and the upper side (e.g., roof) 56 and the lower side (e.g., floor) 57 of the bale chamber 20 is also adjustable.

The knife blade 53a can be configured to move between the forward portion 21 (e.g., discharge outlet 23) and the rearward portion 22 of the bale chamber 20 by way of a manually operated mechanical actuator, such as a screw adjuster mechanism or the like. For example, the knife blade 53a can be connected to the upper and lower mounting bars 60 arranged on the upper side (e.g., roof) 56 and the lower side (e.g., floor) 57 of the baler 10, via screws, bolts, pins, or the like, passing through mounting holes 52a, 52b and 54a, 54b, respectively, which can be configured to mate with pairs of upper and lower openings of a plurality of longitudinally extending series of openings formed in the upper and lower mounting bars 60. Alternatively, the knife blade 53a can be configured to move between the forward portion 21 (e.g., discharge outlet 23) and the rearward portion 22 of the bale chamber 20 by way of actuator 59, which may be an electric linear actuator, a pneumatic cylinder, an electronic actuator, or a hydraulic cylinder, e.g., double acting hydraulic cylinder having a moveable piston and controlled by a hydraulic control circuit, for example. However, embodiments are not limited to this configuration, and in other embodiments, the actuator may be driven by a pulley system, an electric motor, a solenoid, etc.

The angle θ between the knife blade 53a and the upper side (e.g., roof) 56 and the lower side (e.g., floor) 57 of the bale chamber 20 can be adjusted in a similar manner. For example, adjusting the knife blade 53a forwardly or rearwardly relative to the forward portion 21 and the rearward portion 22 of the bale chamber 20 will change the angle θ between the knife blade 53a and the upper side (e.g., roof) 56 and the lower side (e.g., floor) 57 of the bale chamber 20.

The actuator 59 used for adjusting the position and the angle of the knife blade 53a can be connected to the knife blade 53a and to a controller, an actuation circuit, or to other systems of the baler 10 by a hydraulic hose or a conduit, and/or by way of electric wires, cables, a bundle of wires or cables, or a wiring harness that includes various stranded or solid wires that interconnect the actuator with various mechanical, hydraulic, or electrical components of the baler 10, for example.

Further details regarding the actuator may be described in U.S. patent application Ser. No. 18/211,413, which is incorporated by reference herein in its entirety and for all purposes.

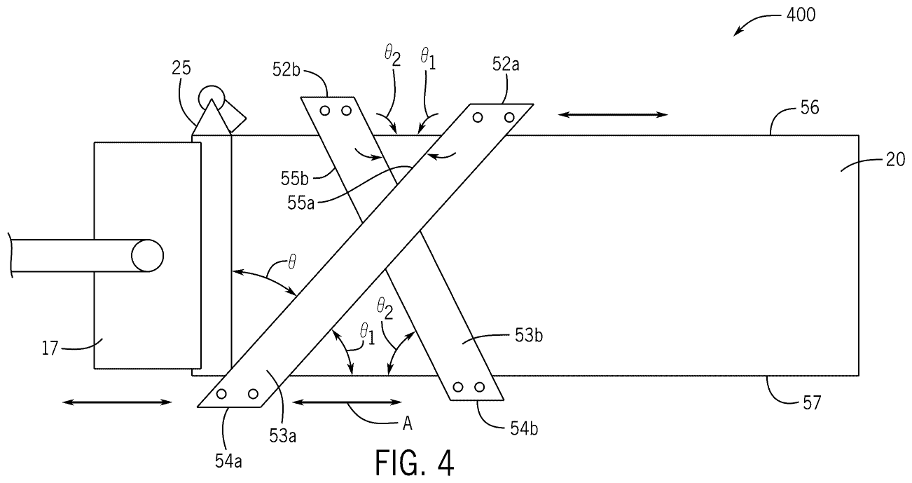

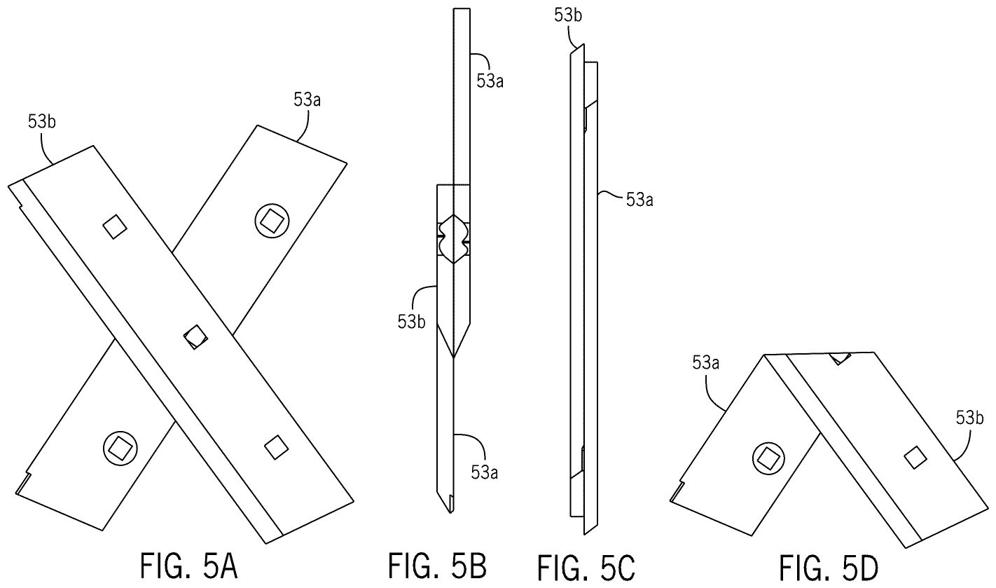

According to another aspect of the present invention, and referring now specifically to FIG. 4, a bale splitting system 400 can include two cutting devices, such as two knives 53a and 53b, for example. Knife 53a in FIG. 4 is the same as knife 53a in FIG. 2, and the details provided above for knife 53a also apply to knife 53b. The two knives 53a and 53b are arranged right next to each other in the bale chamber 20, essentially touching each other, as illustrated in FIGS. 5A-5D, for example. The knife blades 53a, 53b are slanted or angled in opposite directions at angles θ1 and θ2, respectively, relative to the upper side (e.g., roof) 56 and the lower side (e.g., floor) 57 of the bale chamber 20. The positions of the knife blades 53a, 53b relative to the forward portion 21 and the rearward portion 22 of the bale chamber 20 can be fixed. Alternatively, the positions of the knife blades 53a, 53b relative to the forward portion 21 and the rearward portion 22 of the bale chamber 20 can be adjustable. For example, the positions of the knife blades 53a, 53b can be adjusted in the forward direction (left in FIG. 4) or in the rearward direction (right in FIG. 4) relative to the discharge outlet 23 of the bale-forming chamber 20, as shown by arrow A in FIG. 4. The angles θ1 and θ2 between the knife blades 53a, 53b and the upper side (e.g., roof) 56 and the lower side (e.g., floor) 57 of the bale chamber 20, respectively, are also adjustable. The angles θ1 and θ2 may be set to be equal or unequal (as shown).

When the knives 53a, 53b are mounted, the knife blades 53a, 53b extend diagonally in a slanted or angled manner between the upper side (e.g., roof) 56 and the lower side (e.g., floor) 57 of the bale chamber 20. The knife blades 53a, 53b are arranged in a central position between the side walls 31, 32 of the baler 10 and parallel to the side walls 31, 32 of the baler 10.

As shown in FIG. 4, each of the knife blades 53a, 53b has a sharpened angled or serrated edge 55a, 55b, for example. The angled edges 55a, 55b extend diagonally in a slanted or angled manner between the upper side (e.g., roof) 56 and the lower side (e.g., floor) 57 of the bale chamber 20, such that the knife blades 53a, 53b can split the bale 90 in the middle, forming two smaller square bales 90a and 90b. The two smaller square bales 90a and 90b are illustrated schematically in FIG. 3, which is a top plan view of the bale splitting system 200 of FIG. 2, but the concept of splitting the large bale 90 is the same for the embodiment illustrated in FIG. 4.

Turning back to FIG. 4, the sharp edges 55a, 55b of the knife blades 53a, 53b are arranged to face the discharge outlet 23 of the bale-forming chamber 20 proximal to the tying assembly 25, and the bales 90 advancing from the discharge outlet 23 of the bale-forming chamber 20 through the baler 10. The sharp edges 55a, 55b are configured to pass through a respective half portion of the entire height of the bale 90, thereby slicing the bale 90 in the middle, forming two smaller square bales 90a and 90b.

In operation, the formed large square bales 90 advance sequentially through the bale chamber 20, where they are bound with a suitable material, such as twine 92, for example (shown in FIG. 3). As illustrated in FIG. 3, the length dimension of the bales 90 extends transversely between the side walls 31, 32 of the baler 10, and the height dimension of the bales 90 extends between the upper side (e.g., roof) 56 and the lower side (e.g., floor) 57 of the baler 10. Before the bound with twine 92 bale 90 is discharged from the discharge chute of the baler 10 to the ground surface of the field, the bound bale 90 is pushed against and past the knife blade 53a. The knife blades 53a, 53b split each bale 90 through a respective half portion of the entire height of the bale 90, while the bale 90 is still in the bale chamber 20, forming two small bales 90a and 90b (FIG. 3).

The knife blades 53a, 53b are arranged in a central position substantially corresponding to the forward-rearward bale travel axis 100 of the bale chamber 20 (FIG. 3) such that the knife blades 53a, 53b split each bale 90 along the centerline 100 of the bale 90 and between the twine 92, without cutting the twine 92.

Turning back to FIG. 4, the positions of the knife blade 53a, 53b can be adjusted relative to the discharge outlet 23 of the bale-forming chamber 20, and relative to the forward portion 21 and the rearward portion 22 of the bale chamber 20. The angles θ1 and θ2 between the knife blades 53a, 53b and the upper side (e.g., roof) 56 and the lower side (e.g., floor) 57 of the bale chamber 20, respectively, are also adjustable.

The knife blades 53a, 53b can be configured to move between the forward portion 21 (e.g., discharge outlet 23) and the rearward portion 22 of the bale chamber 20 by way of a manually operated mechanical actuator, such as a screw adjuster mechanism or the like. For example, the knife blade 53a can be connected to the upper and lower mounting bars 60 arranged on the upper side (e.g., roof) 56 and the lower side (e.g., floor) 57 of the baler 10, via screws, bolts, pins, or the like, passing through mounting holes 52a, 52b and 54a, 54b, respectively, which can be configured to mate with pairs of upper and lower openings of a plurality of longitudinally extending series of openings formed in the upper and lower mounting bars 60.

Alternatively, the knife blades 53a, 53b can be configured to move between the forward portion 21 (e.g., discharge outlet 23) and the rearward portion 22 of the bale chamber 20 by way of electric linear actuators, pneumatic cylinders, electronic actuators, or hydraulic cylinders, e.g., double acting hydraulic cylinder having a moveable piston and controlled by a hydraulic control circuit. However, embodiments are not limited to this configuration, and in other embodiments, the actuators may be driven by a pulley system, an electric motor, a solenoid, etc.

The angles 01 and 02 between the knife blades 53a, 53b and the upper side (e.g., roof) 56 and the lower side (e.g., floor) 57 of the bale chamber 20, respectively, can be adjusted in a similar manner. For example, adjusting the knife blades 53a, 53b forwardly or rearwardly relative to the forward portion 21 and the rearward portion 22 of the bale chamber 20 will change the angles θ1 and θ2 between the knife blades 53a, 53b and the upper side (e.g., roof) 56 and the lower side (e.g., floor) 57 of the bale chamber 20.

The actuators used for adjusting the position and the angle of the knife blades 53a, 53b can be connected to the knife blades 53a, 53b and to a controller, an actuation circuit, or to other systems of the baler 10 by a hydraulic hose or a conduit, and/or by way of electric wires, cables, a bundle of wires or cables, or a wiring harness that includes various stranded or solid wires that interconnect the actuators with various mechanical, hydraulic, or electrical components of the baler 10, for example.

Further details regarding the actuators may be described in U.S. patent application Ser. No. 18/211,413, which is incorporated by reference herein in its entirety and for all purposes.

The bale splitting systems 200 and 400 illustrated in the figures and described above increase the throughput of the baler and produce multiple small square bales simultaneously, unlike a conventional small baler that only produces one bale at a time, by splitting a large square bale that enters the bale-forming chamber into two small square bales with a cutting mechanism, significantly improving the baling capacity.

The bale splitting system 200 and 400 illustrated in the figures and described above can be implemented in any hay and forage agricultural vehicle that harvests a grass type crop, including but not limited to small square baler pickups or large square baler pickups, for example.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural baler, comprising:
a bale chamber having a discharge outlet; and
a bale splitting system including:
a cutting mechanism downstream of the discharge outlet, the cutting mechanism being configured to split a bale or crop material discharged from the discharge outlet in half and output two smaller bales or two smaller stacks of crop material, wherein the cutting mechanism is angled forwardly or rearwardly relative to a top wall or a bottom wall of the bale chamber.

2. The agricultural baler of claim 1, wherein a position of the cutting mechanism relative to a front wall and a rear wall of the bale chamber is adjustable.

3. The agricultural baler of claim 1, wherein an angle between the cutting mechanism and the bottom wall or the top wall of the bale chamber is adjustable.

4. The agricultural baler of claim 1, wherein the cutting mechanism comprises a knife having a knife blade with a sharpened angled edge.

5. The agricultural baler of claim 4, wherein the sharpened angled edge is arranged to face the discharge outlet proximal to a tying assembly.

6. The agricultural baler of claim 4, wherein the knife blade extends at an angle along a height of the bale chamber.

7. The agricultural baler of claim 4, wherein the sharpened angled edge is configured to slice the bale at least in half by the sharpened angled edge passing at least through a height of the bale.

8. The agricultural baler of claim 4, wherein the cutting mechanism is positioned to split the bale after the bale is bound with twine and wherein the sharpened angled edge is configured to slice the bale in half without cutting the twine.

9. The agricultural baler of claim 4, wherein the cutting mechanism is positioned to split the bale before the bale is bound with twine.

10. The agricultural baler of claim 4, wherein the knife is mounted to a mount arranged at an upper side of the agricultural baler and/or at a lower side of the agricultural baler.

11. An agricultural baler, comprising:
a bale chamber having a discharge outlet; and
a bale splitting system including:
two cutting mechanisms that face the discharge outlet, each of the two cutting mechanisms being angled in an opposite direction relative to the bottom wall or the top wall of the bale chamber.

12. The agricultural baler of claim 11, wherein a respective position of each of the two cutting mechanisms relative to a front wall and a rear wall of the bale chamber is adjustable.

13. The agricultural baler of claim 11, wherein each of the two cutting mechanisms comprises a knife having a knife blade with a sharpened angled edge.

14. The agricultural baler of claim 13, wherein each sharpened angled edge is arranged to face the discharge outlet of the bale chamber proximal to a tying assembly.

15. The agricultural baler of claim 13, wherein each knife blade extends along a height of the bale chamber at a different angle relative to the bottom wall or the top wall of the bale chamber.

16. The agricultural baler of claim 13, wherein each sharpened angled edge is configured to slice the bale at least in half by each sharpened angled edge passing at least through a respective half portion of a height of the bale.

17. The agricultural baler of claim 13, wherein the two cutting mechanisms are positioned to split the bale after the bale is bound with twine and wherein each sharpened angled edge is configured to slice the bale in half without cutting the twine.

18. The agricultural baler of claim 13, wherein the two cutting mechanisms are positioned to split the bale before the bale is bound with twine.

19. The agricultural baler of claim 1, wherein the bale splitting system is a separate structure configured to be added or retro-fitted into the agricultural baler.

20. The agricultural baler of claim 1, wherein the bale splitting system is built into the agricultural baler.
